(19) United States
(12) Patent Application Publication
(10) Pub. No.: US 2026/0212373 A1
(43) Pub. Date: Jul. 23, 2026

(54) POLICY RULES GUARDRAIL: NEUROSYMBOLIC SYSTEM FOR DETERMINISTIC POLICY COMPLIANCE VERIFICATION

(71) Applicant: Jaxon, Inc., Boston, MA (US)

(72) Inventors: Gregory Harman, Castro Valley, CA (US); Robert Jones, Williamsburg, VA (US)

(73) Assignee: Jaxon, Inc., Boston, MA (US)

(21) Appl. No.: 19/443,455

(22) Filed: Jan. 8, 2026

Related U.S. Application Data
(60) Provisional application No. 63/747,597, filed on Jan. 21, 2025.

(51) Int. Cl. G06Q 30/018

(52) U.S. Cl. CPC G06Q 30/018

(57) ABSTRACT

A computer-based neurosymbolic system for deterministic policy compliance verification combines neural language models for flexible natural language understanding with symbolic reasoning for deterministic, auditable rule evaluation. The system operates in two phases: (1) Configuration Time, where policy documents 20 are processed to automatically extract formal rules 10 and generate a minimum viable extraction schema 11, 23 containing only information required by the rules; (2) Inference Time, where input documents 24 are processed to extract only policy-relevant information 12, 17, which is evaluated against the rules 10 using deterministic symbolic reasoning. In an embodiment, information extraction 25 uses automatically generated questions 23 with explicit UNKNOWN handling, and compliance is determined using three-valued logic (compliant/non-compliant/cannot-determine), providing epistemic clarity and thwarting hallucinations. The system supports execution via an SMT solver 31 or via trained neural models 45 while maintaining determinism and explainability.

### RELATED PATENT APPLICATION

This patent application claims the priority benefit of commonly-assigned U.S. provisional patent application 63/747,597 filed Jan. 21, 2025, entitled “Policy Rules Guardrail,” which is hereby incorporated by reference in its entirety into the present patent application.

### FIELD OF THE INVENTION

The present invention relates generally to computer systems for verifying compliance with policies (e. g, legal requirements, company policies).

### BACKGROUND OF THE INVENTION

Organizations in regulated sectors routinely process complex documents, workflows, and transactions that must conform to policy constraints derived from statutes, technical standards, internal procedures, and contractual terms. These policies are often ambiguously worded, updated frequently, and vary across jurisdictions or business units. Ensuring compliance at scale requires systems capable of interpreting natural-language policies, extracting relevant facts from heterogeneous inputs, and making determinations that are defensible to auditors and regulators.

However, traditional approaches operate under rigid assumptions: they expect complete information, stable rule sets, and structured inputs—all of which break down in real-world compliance environments. This creates a growing gap between operational reality and the capabilities of existing compliance-verification technologies.

### Limitations of Rule-Based Systems

Conventional rule-based engines depend on manual authoring of rules in specialized formats. Policies must be translated into technical expressions or logic statements, often requiring cross-functional coordination between domain experts and software engineers. This process is slow, difficult to scale, and prone to inconsistencies when multiple authors encode rules differently. When regulations change, entire rule sets may need to be revised or regenerated. Organizations with hundreds or thousands of rules face large maintenance burdens and significant risk of outdated or incorrect rules persisting in production systems. These limitations restrict agility and undermine confidence in automated compliance solutions.

### Limitations of Machine-Learning and Language-Model Systems

Machine-learning systems interpret text probabilistically rather than deterministically. While they can identify patterns and extract candidate facts, their outputs lack guaranteed correctness, repeatability, or traceability. Large language models, though capable of sophisticated natural-language reasoning, generate responses using statistical inference rather than grounded logic, leading to hallucinations, spurious correlations, and sensitivity to prompt variation.

Critically, such systems do not provide explicit semantics for unknown information. When confronted with missing data, they often infer unsupported answers or assign confidence values that do not map cleanly to logical truth conditions. As a result, their compliance determinations are difficult to audit and insufficient for applications requiring explainability or regulatory defensibility.

### Limitations of Knowledge-Graph and Ontology-Based Systems

Knowledge-graph approaches typically attempt to construct comprehensive semantic models of a domain. Developing such ontologies requires extensive expert involvement, lengthy iteration cycles, and non-trivial governance processes. Once constructed, these ontologies are high dimensional and contain far more concepts and relationships than needed for any specific compliance rule.

Extraction systems built on these ontologies must search broad concept spaces, increasing the likelihood of irrelevant extractions and overfitting. As policies change, ontologies must be updated or restructured, further adding to maintenance overhead. These systems are powerful but ill-suited to narrowly scoped, rule-specific information extraction tasks.

### The Uncertainty Handling Problem

A cross-cutting limitation of existing compliance technologies is their ineptitude in handling missing or incomplete information. Real-world inputs—such as contracts, logs, forms, system artifacts, or communications—frequently omit values needed for a correct or useful determination. Existing systems respond with inadequate mechanisms:
Confidence scores conflate different types of uncertainty and lack principled logical semantics.
Binary thresholding collapses nuanced degrees of uncertainty into yes/no outcomes, often hiding the distinction between “false” and “unknown.”
Hard failures occur in systems that require fully populated input schemas.
Implicit guessing by probabilistic or neural models produces incorrect determinations that are difficult to detect or audit.
   These behaviors undermine determinism, consistency, and trustworthiness—especially in regulated domains where the distinction between false, true, and unknown is essential.

### Summary of Needs That are Satisfied by the Present Invention

Accordingly, there is a need for a system that:
automatically extracts policy rules directly from natural-language policy sources without manual ontology engineering,
generates minimal, rule-specific information extraction schemas rather than comprehensive domain models,
extracts only policy-relevant information from inputs, using flexible neural models,
evaluates compliance deterministically using symbolic reasoning with transparent decision paths, and
explicitly represents and propagates uncertainty, enabling three-valued outcomes—compliant, non-compliant, or cannot-determine.

### SUMMARY OF THE INVENTION

The present invention provides a neurosymbolic system for deterministic policy compliance verification that addresses the limitations of the prior art through a novel two-phase architecture: a Configuration Phase featuring automatic policy rule 10 extraction having minimal information extraction, and an Inference Phase adapted to quickly evaluate an input document 24 against the policy rules 10.

### Two-phase Architecture With Minimum Viable Extraction

The method of the present invention operates in two distinct time phases:
Configuration Time (Policy Processing Phase): Policy documents 20 are processed once to extract 2 formal executable policy rules 10. An extraction schema (ontology 11, question set 23, or alternative structured representation) is automatically generated 3, 23. The extraction schema contains only the minimum set of concepts required to evaluate the extracted rules 10. This “backward derivation” from rules 10 to required information 11, 23 dramatically reduces complexity compared to comprehensive ontology engineering.
Inference Time (Compliance Evaluation Phase): Input documents 24 are processed 25 to extract only the policy-relevant information 12, 17 specified in the minimal extraction schema 11, 23. Extracted information 12, 17 is evaluated 7, 27 against the policy rules 10 using deterministic symbolic reasoning. Compliance determinations 14, 28 are auditable and reproducible.

### Triple-Based Information Extraction

In a first embodiment, illustrated in FIG. 1, during Configuration Time a main computer (not illustrated, but more fully described below) extracts 2 policy rules 10 from one or more natural language policy documents 20 using a first language model (such as a Large Language Model (LLM); not illustrated), translating policy statements contained in the policy document(s) into a set of policy rules 10 embodied in executable code or formal logic; analyzes the extracted rules 10 to identify required ontological concepts; and generates 3 a minimum viable ontology 11 containing only those concepts necessary for rule 10 evaluation. Then at Inference Time, the main computer extracts 5 a set of triples 12 (subject-predicate-object statements) from input documents 24 using the language model guided by the ontology 11; constructs 6 a knowledge graph 13 or alternative graph representation from the extracted triples 12; and evaluates 7 the policy rules 10 against the knowledge graph 13 to determine 14 compliance.

### Question-Based Extraction With Three-Valued Logic

In a second embodiment, illustrated in FIGS. 2 and 3, during Configuration Time the main computer extracts 2 policy rules 10 from natural language policy document(s) 20 using the first language model as before, and translates the policy rules 10 into a set of DSL rules using a domain-specific language 19 (DSL) that supports three-valued logic; analyzes variable names in the DSL rules 21 to automatically generate 22 natural language questions 23 targeting specific policy-relevant information; and determines data types for each question 23 (Boolean, Numeric with units, Enumerated values, or other data types). Then at Inference Time, the main computer prompts a second language model (such as an LLM; not illustrated) to answer 25 each generated question 23 against information contained in the input document 24, with explicit instructions to return as question-answer pairs 17 an UNKNOWN value if the question 23 cannot be answered from the available information. The first language model and the second language model may be the same language model. Alternatively, the first and second language models may be different language models selected based upon task-specific performance requirements.

The second language model optionally applies 29 an entailment filter to verify that question-answer pairs 17 are entailed by the input document 24. The main computer then binds 26 answered values 17 to DSL variables, with unanswered or unbound variables treated as UNKNOWN; evaluates 27 the DSL rules 21 using an SMT (Satisfiability Modulo Theories) solver 31 or equivalent symbolic reasoning engine; and produces three-valued compliance determinations 28, which can be one of: COMPLIANT (all applicable rules 21 evaluate to true), NON-COMPLIANT (at least one rule 21 evaluates to false), or CANNOT-DETERMINE (at least one rule 21 evaluates to UNKNOWN due to missing information).

### Key Innovation: UNKNOWN as Typed Value

A key distinguishing feature of the question-based embodiment illustrated in FIG. 2 or 3 is the treatment of uncertainty. Prior art approaches use confidence scores (e.g., 0.0 to 1.0) representing probabilistic estimates, with arbitrary thresholds determining acceptance or rejection. The present invention treats UNKNOWN as an explicit, full member of each data type's value space: BooleanValue∈{TRUE, FALSE, UNKNOWN}; NumericValue∈{ [symbol] ∪{UNKNOWN}}; EnumValue∈{enum_member₁, enum_member₂, . . . , UNKNOWN}.

UNKNOWN participates in logical operations according to Kleene three-valued logic semantics: TRUE∧UNKNOWN=UNKNOWN (cannot determine if conjunction is satisfied); FALSE∧UNKNOWN=FALSE (conjunction fails regardless); TRUE∨UNKNOWN=TRUE (disjunction succeeds regardless); FALSE∨UNKNOWN=UNKNOWN (cannot determine if disjunction is satisfied).

This approach provides: (1) epistemic clarity, with UNKNOWN explicitly representing missing information rather than conflating it with confidence in extraction quality; (2) audit trails, with compliance reports 18 identifying exactly which information gaps prevented a determination; (3) logical soundness, ensuring partial information is correctly propagated through complex rule expressions without incorrect inferences; (4) elimination of arbitrary thresholds; and (5) prevention of hallucination impact by explicitly prompting the language model to return UNKNOWN rather than guessing.

### Alternative Evaluation: Neural Model Evaluation

In an alternative embodiment of evaluation step 27, rather than using an SMT solver 31 to evaluate the DSL rules 21 symbolically, the main computer compiles (step 36 of FIG. 3) DSL logic 21 into neural network form by means of an AND-inverter graph. The logic layers of the neural network 45 are then frozen at step 50 to become frozen logic layers 39, and are appended to a language model 45 having a frozen embedding model 37 and a trainable classifier 38, which can be fine-tuned 40 to distill inputs for the logic layers 39 from the original input 21, emulating the original set of LLM-driven question/answer pairs 17 or extracted triples 12. The neural model 45 receives both the rule representation 21 and the extracted information 17, 12, producing compliance determinations 28 with preserved three-valued logic semantics. This alternative embodiment provides potential performance advantages for high-throughput scenarios while maintaining determinism and explainability through architectural constraints.

### System Advantages

The present invention provides numerous advantages over the prior art: automatic policy rule extraction 2; minimal information extraction 2 (only policy-relevant concepts 10 are extracted); backward derivation (extraction schema 11, 23 derived from rules 10); deterministic evaluation 7, 27 (reproducible and auditable); explicit uncertainty handling (three-valued logic 17 with UNKNOWN as typed value); hallucination prevention (explicit prompting 25 for UNKNOWN); flexible execution (symbolic 34 or neural 45 mechanisms); and comprehensive audit trails 14, 18.

### BRIEF DESCRIPTION OF THE DRAWINGS

FIG. 1 is a system architecture/flow diagram illustrating the two-phase workflow of a first embodiment of the present invention, showing the Configuration Phase (policy document processing 1, rule extraction 2, and ontology generation 3) and the Inference Phase (input document processing 4, triple extraction 5, knowledge graph construction 6, and rule evaluation 7).

FIG. 2 is a flowchart illustrating a second (question-based information extraction) embodiment of the present invention with UNKNOWN handling, showing Configuration Time (policy document(s) 20→rule extraction 2→DSL rules 21→question generation 22→question schema 23), and Inference Time (input document 24→question answering 25 with UNKNOWN prompting→optional entailment verification 29→variable bindings 26→three-valued logic evaluation 27→three-way compliance determination 28 with information gap reporting 18).

FIG. 3 is a system architecture diagram elaborating upon Logic Evaluation step 27 of FIG. 2, comparing the SMT solver 31 rule evaluation 27 embodiment against the alternative neural model 45 rule evaluation 27 embodiment, showing parallel execution paths and performance characteristics, and a method 40 of neural training/distillation bootstrapped via the SMT execution path 34.

### DETAILED DESCRIPTION OF PREFERRED EMBODIMENTS

### I. System Architecture Overview

### A. Two-Phase Operational Model

The inventive Policy Rules Guardrail (PRG) computer system described herein implements a neurosymbolic architecture that bridges the gap between flexible natural language understanding and deterministic symbolic reasoning. The system operates according to a strict separation between Configuration Time and Inference Time.

Configuration Time (Configuration Phase) is executed once upon introduction of a new policy, or else infrequently, e.g., whenever a policy changes. The input consists of one or more natural language policy documents 20. The output comprises formal executable policy rules 10 and a minimal extraction schema 11, 23. The duration of the processing in Configuration Time is typically several minutes to several hours, and is not performance-critical. The Configuration Time (Phase) employs language model-powered analysis and code generation.

Inference Time (Inference Phase) is executed each time a compliance evaluation is needed for a particular input document 24. Document 24 is a natural language document that is to be evaluated for compliance with the set of policies. The output of Inference Time comprises a compliance determination 28 of the input document 24 (compliant, non-compliant, or cannot-determine) with supporting evidence. The duration of Inference Time is typically several seconds or even milliseconds, and is performance-critical for real-time applications. The Inference Time (Phase) employs schema-guided information extraction 3, 25 and deterministic symbolic evaluation 7, 27.

This architectural separation between Configuration Phase and Inference Phase provides amortized cost (expensive language model processing of policy documents occurs just once during the execution of each Configuration Phase; while lightweight rapid extraction is performed for each input document 24 processed ty the Inference Phase), consistency (policy interpretation is fixed by the Configuration Phase; all evaluations use identical rule logic), auditability (rule extraction 2 can be reviewed by domain experts before deployment), and performance (deterministic evaluation during execution of the Inference Phase is fast and predictable).

### B. Minimum Viable Information Extraction

A core innovation of the present invention is the principle of minimum viable extraction 2: the system extracts 2 only the information required to evaluate the specific policy rules 10 at hand, rather than attempting comprehensive information extraction. Traditional knowledge graph systems often aim to extract all entities, attributes, and relationships from input documents, creating large, complex graph structures with high dimensionality, increased error rates, high computational cost, and maintenance burdens.

The present invention inverts the prior art paradigm through backward derivation: starting from policy documents 20 and identifying 2 the minimal set of policy rules 10 required to evaluate the policies embodied in the policy documents 20. For example, a comprehensive extraction approach for a healthcare policy might extract hundreds of medical procedures, facility types, provider credentials, patient demographics, insurance concepts, and regulatory relationships (thousands of total concepts). On the other hand, the minimum viable extraction approach of the present invention for a specific policy like “Procedures requiring general anesthesia must have board-certified anesthesiologists present” extracts 2 only: Does the procedure require general anesthesia? (Boolean); Is a board-certified anesthesiologist present? (Boolean). This innovative approach reduces extraction complexity by orders of magnitude, decreases error rates, improves performance, and requires no manual ontology engineering.

### II. Triple-Based Information Extraction Embodiment

### A. Configuration Time Processing

### 1. Policy Document Input and Preprocessing

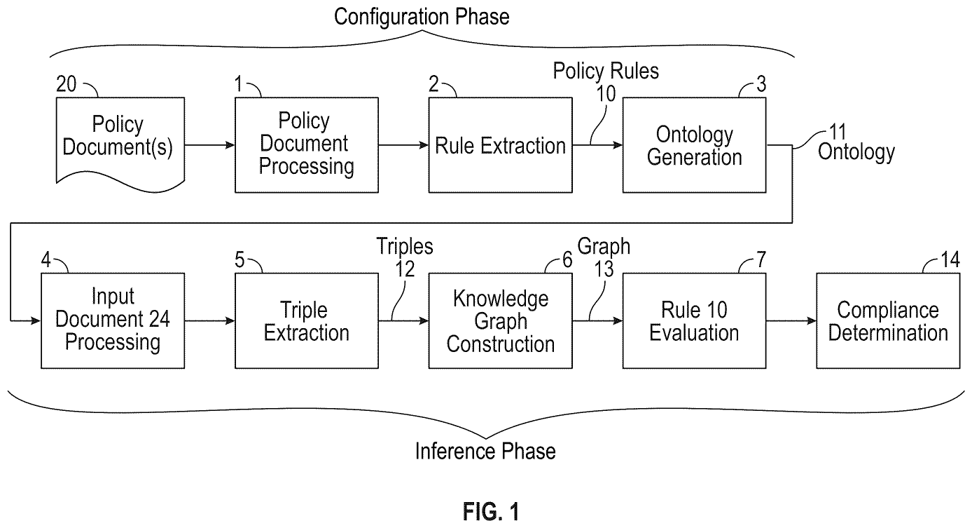

In a first embodiment, illustrated in FIG. 1, the main computer accepts policy document(s) 20 in various natural language formats. The policy documents 20 are preprocessed to extract textual content, preserve document structure (headings, sections, lists), resolve cross-references, and normalize formatting.

### 2. Automatic Policy Rule Extraction

A first language model (e.g., LLM; not illustrated) is prompted to analyze the policy document(s) 20 and extract 2 formal policy rules 10. The first language model is instructed to identify normative statements (requirements, prohibitions, permissions), extract conditions and consequences, resolve references and dependencies between and among policy statements, and translate policy logic into executable code or formal logic expressions 10. The first language model leverages its pre-trained knowledge of policy language patterns, common compliance requirements, and logical reasoning to perform this translation from natural language 20 to formal logic 10.

### 3. Ontology Generation Via Rule Analysis

After extracting 2 policy rules 10, the main computer analyzes 3 the rules 10 to identify required ontological concepts. This analysis identifies entity types (objects that must be recognized in the input documents 20), attributes (properties of entities that must be extracted), and relationships (connections between and among entities that must be identified).

The main computer generates 3 a minimum viable ontology 11 containing only these policy-required concepts. This ontology 11 is significantly smaller than a comprehensive domain ontology, as it includes only that information necessary for the specific policy rules 10 being enforced. The ontology 11 is represented in a structured format specifying entity type definitions, attribute specifications (name, data type, constraints), relationship type definitions, and cardinality constraints.

### 4. Triple Extraction Template Generation

Based on the minimum viable ontology 11, the main computer generates extraction templates that guide the language model during Inference Time. These templates specify target entity types to identify, attributes to extract for each entity, relationships to identify between entities, and validation rules for extracted information.

### B. Inference Time Processing

### 1. Input Document Processing

At Inference Time, the main computer identifies a natural language input document 24 to be evaluated for policy compliance. The input document 24 is preprocessed 4 similarly to the preprocessing of policy documents 20 described above in conjunction with the description of Configuration Time.

### 2. Triple Extraction Via Language Model

The second language model is then prompted at step 5 to extract a set of triples 12 (subject-predicate-object statements) from the input document 24 according to the ontology 11 and extraction templates generated during Configuration Time. The second language model receives from the main computer the text of the input document 24, the ontology specification 11, instructions to extract only that information which matches the ontology 11, and format requirements for the triple 12 output. The second language model performs entity recognition, attribute extraction, and relationship identification, producing at step 5 structured triples 12 that conform to the ontology 11.

### 3. Knowledge Graph Construction

The extracted triples 12 are then aggregated by the main computer at step 6 into a knowledge graph data structure 6, which may be implemented as a graph database, an in-memory graph representation, or an alternative structured representation that organizes the extracted information.

### 4. Rule Evaluation Against Knowledge Graph

The policy rules 10 extracted during Configuration Time are then evaluated by the main computer at step 7 against the constructed knowledge graph 13 using deterministic symbolic reasoning. This evaluation 7 may involve graph pattern matching (rules 10 expressed as graph queries executed against the knowledge graph 13), procedural evaluation (rules 10 expressed as executable code that query the knowledge graph 13 programmatically), or logical inference (rules 10 expressed as formal logic evaluated using a theorem prover or reasoning engine).

The evaluation 7 produces a binary compliance determination 14: COMPLIANT (all applicable policy rules 10 are satisfied) or NON-COMPLIANT (at least one policy rule 10 is violated).

### 5. Evidence and Provenance Tracking

Throughout the evaluation process, the main computer maintains provenance information identifying which input document 24 segments were used to extract 5 each triple 12, which triples 12 were used to evaluate 7 each rule 10, and which rules 10 passed or failed. This provenance enables the main computer to generate detailed compliance reports explaining why a particular compliance determination 14 was reached, which specific policy rules 10 were violated (if non-compliant), which input information supported the compliance determination 14, and audit trails linking compliance determinations 14 back to source policy documents 20 and input documents 24.

### C. Advantages and Design Considerations

The triple-based implementation utilized in this first (FIG. 1) embodiment provides significant advantages over the prior art: no manual ontology engineering is needed (the ontology 11 is automatically derived from policy rules 10), minimal extraction 5 complexity (only policy-relevant triples 12 are extracted), deterministic evaluation (graph 13 queries and rule evaluation 7 are reproducible), audit trails (complete provenance from input documents 24 through rules 10 to compliance determination 14), flexible knowledge representation (not limited to specific graph formalisms), use of a language model for flexibility (the natural language understanding inherent in the language model handles linguistic variation), and symbolic reasoning for reliability (deterministic evaluation prevents non-deterministic neural outputs).

This FIG. 1 embodiment is particularly suited for complex relational information where policy rules 10 require understanding relationships between and among multiple entities; entity-centric policies focusing on properties of recurring entities; scenarios where reusable knowledge enables building a knowledge graph 13 once, then evaluating many different policies against it; and applications benefiting from graph reasoning algorithms (e.g., transitive relationships, path finding, community detection).

### III. Question-Based Extraction Embodiment With Three-Valued Logic

### A. Configuration Time Processing

### 1. Policy Rule Extraction to Domain-Specific Language

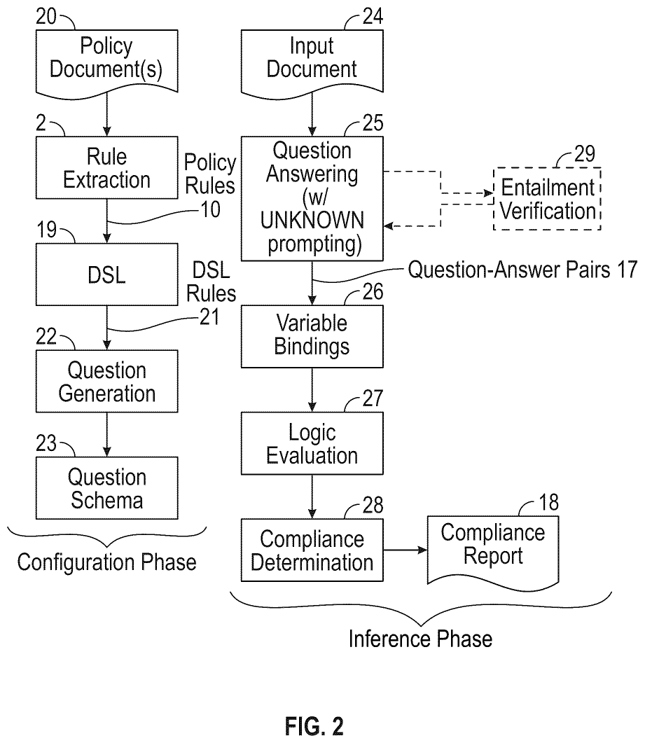

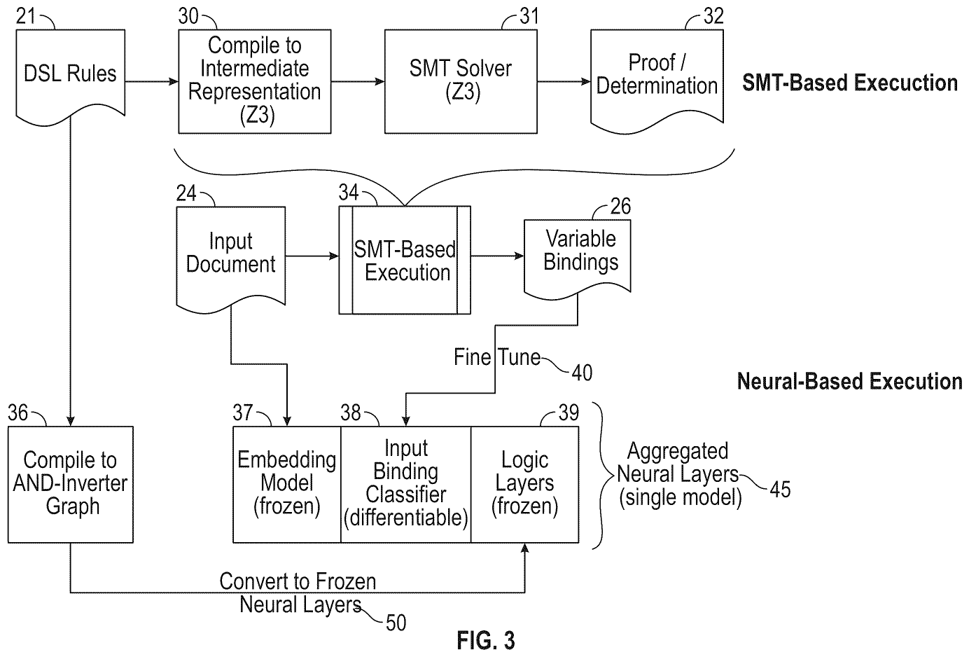

The question-based extraction embodiment with three-valued logic (second embodiment) is illustrated in FIGS. 2 and 3. Similar to the first (FIG. 1) embodiment described above, policy documents(s) 20 are processed using a first language model to extract formal policy rules 10. The first language model (not illustrated) may the same as, or similar to, the first language model referred to above in conjunction with the first embodiment. In this question-based second embodiment, the policy rules 10 are translated by a custom domain-specific language 19 (DSL) into a set of DSL rules 21 specifically designed to support three-valued logic. DSL 19 is fully explained in commonly-owned U.S. patent application Ser. No. 18/955,116 filed Nov. 21, 2024, which patent application is hereby incorporated in its entirely into the present patent application. DSL 19 is designed to adhere to the following principles: variables represent policy-relevant information; expressions combine variables using logical operators (AND, OR, NOT, comparison operators); each expression evaluates to one of three values (TRUE, FALSE, or UNKNOWN); and unbound variables are implicitly UNKNOWN.

### 2. Question Generation From DSL Variables

A key innovation of this second embodiment is the automatic generation 22 of natural language questions 23 from DSL variable names. The main computer analyzes each variable in the DSL rules 21 and uses a third language model (which may be the same language model as any of the language models previously described) to: (1) generate 22 a natural language question 23 that would elicit the information represented by the variable; (2) determine the appropriate data type for the answer; (3) when the data type is Numeric, determine units of measurement; (4) when the data type is Enumerated, determine possible enumeration values; and (5) optionally generate clarifying context or constraints.

The DSL 19 follows a best practice of using descriptive variable names. The variable name serves as a semantic hint for question generation 22.

The language model determines at step 22 the appropriate data type for each question: Boolean (yes/no questions, binary properties); Numeric (quantities, measurements, counts, with unit specifications); Enumerated (“enum”; categorical values from a fixed set, with UNKNOWN always included as an enum member); or String (free-text information, used sparingly).

### 3. Question Schema Generation

The generated questions 23 and their associated metadata (data type, units, enum values) form a question schema 23 that serves an analogous role to the ontology 11 in the first embodiment. By way of comparison, the question schema 23 is generally simpler than ontology 11: no entity type modeling is required, no relationship modeling is required, each question 23 independently targets a specific piece of information, and the structure is flat rather than graph-based.

The question schema 23 is stored in a structured format in the main computer for use during Inference Time.

### B. Inference Time Processing

### 1. Input Document Reception

At Inference Time for the second embodiment, the main computer selects a natural language input document 24 to be evaluated for policy compliance.

### 2. Question Answering With Explicit UNKNOWN Prompting

For each question in the question schema 23, the main computer prompts the second language model (which may or may not be the same as the first language model) to answer 25 the question 23 based on the information contained in the input document 24. This is the core information extraction mechanism 25 in the second embodiment.

A issued by the main computer to the second language model explicitly instructs the second language model to return UNKNOWN when the question 23 cannot be answered from the available information. The prompt instructs the second language model to: (1) read the document 24 carefully; (2) when the document 24 contains information that directly answers the question 23, provide the answer 17; (3) when the document 24 does NOT contain sufficient information to answer the question 23, respond with UNKNOWN; (4) NOT guess or infer information that is not explicitly stated; and (5) NOT use background knowledge beyond what is in the input document 24. The output of step 25 is a set of question-answer pairs 17.

This explicit instruction to default to UNKNOWN rather than guessing is an important differentiator from prior art systems that attempt to maximize answer coverage. By guessing, these prior art systems may produce unwanted hallucinations.

The prompt sent to the second language model is adapted based on the question's data type, and request Boolean, Numeric, or Enum responses 17 with UNKNOWN as an option.

### 3. Optional Entailment Filtering

To provide additional assurance against language model hallucination, the main computer optionally applies 29 an entailment filter to verify question-answer pairs 17. In this variation, after the second language model provides 25 an answer 17 to a question 23, a second call to the second language model from the main computer evaluates 29 whether a premise (a relevant excerpt from an input document 24) entails a hypothesis (a question-answer pair 17 reformulated as a declarative statement).

When entailment verification 29 fails, the answer 17 produced by the second language model is downgraded to UNKNOWN even if the second language model initially provided a specific answer 17. This conservative approach prioritizes precision over recall, ensuring that compliance determinations 28 are based on information genuinely present in the input document 24.

Entailment filtering 29 is made to be optional, because it 29 adds computational cost. In deployments where the second language model is highly reliable and the cost of false positives is low, entailment filtering 29 may be disabled. In high-stakes compliance scenarios where false positives could have serious consequences, entailment filtering 29 provides an additional safety layer.

### 4. Variable Binding and UNKNOWN Handling

After question answering 25 completes, the main computer binds 26 the answers 17 to variables in the DSL rules 21. If a question 23 was not asked at step 25 (e.g., due to conditional logic where certain questions 23 are relevant only if previous answers 17 meet certain criteria), the corresponding variable 17 remains unbound and is treated as UNKNOWN during evaluation step 27.

### 5. Three-valued Logic Evaluation

The DSL rules 21 are evaluated at step 27 using the variable bindings 26 according to Kleene three-valued logic semantics (also known as K3 or strong Kleene logic).

Kleene three-valued logic operates according to the following truth tables:
NOT (Negation): NOT(TRUE)=FALSE; NOT(FALSE)=TRUE; NOT(UNKNOWN)=UNKNOWN.
AND (Conjunction): TRUE AND TRUE=TRUE; TRUE AND FALSE=FALSE; TRUE AND UNKNOWN=UNKNOWN; FALSE AND TRUE=FALSE; FALSE AND FALSE=FALSE; FALSE AND UNKNOWN=FALSE (short-circuit); UNKNOWN AND TRUE=UNKNOWN; UNKNOWN AND FALSE=FALSE (short-circuit); UNKNOWN AND UNKNOWN=UNKNOWN.
OR (Disjunction): TRUE OR TRUE=TRUE; TRUE OR FALSE=TRUE; TRUE OR UNKNOWN=TRUE (short-circuit); FALSE OR TRUE=TRUE; FALSE OR FALSE=FALSE; FALSE OR UNKNOWN=UNKNOWN; UNKNOWN OR TRUE=TRUE (short-circuit); UNKNOWN OR FALSE=UNKNOWN; UNKNOWN OR UNKNOWN=UNKNOWN.

Key properties of Kleene logic include: (1) short-circuit evaluation 27 when possible to determine result regardless of unknown values (e.g., FALSE AND UNKNOWN=FALSE); (2) conservative propagation when the result depends on the unknown value (e.g., TRUE AND UNKNOWN=UNKNOWN); and (3) logical soundness ensuring the logic never produces FALSE when TRUE is possible given complete information, and never produces TRUE when FALSE is possible.

### 6. Compliance Determination and Reporting

After evaluating all the DSL rules 21, the main computer aggregates the results to produce a final compliance determination 28 having three possible values:
COMPLIANT (TRUE): All applicable policy rules 21 evaluate to TRUE.
NON-COMPLIANT (FALSE): At least one policy rule 21 evaluates to FALSE.
CANNOT-DETERMINE (UNKNOWN): No rules 21 evaluate to FALSE, but at least one rule 21 evaluates to UNKNOWN.

The main computer also generates a detailed compliance report 18 including: (1) the overall determination 28 (COMPLIANT, NON-COMPLIANT, or CANNOT-DETERMINE); (2) rule-by-rule results with evaluation result and supporting evidence for each policy rule 21; (3) identification of information gaps explicitly identifying which questions 23 could not be answered when the determination is CANNOT-DETERMINE; (4) identification of violated policies with specific policy rules 21 that failed and why when the determination is NON-COMPLIANT; and (5) a complete audit trail with provenance from the input document 24 through questions, answers, variable bindings, and rule evaluation.

This reporting structure 18 provides actionable guidance: the user knows exactly what additional information is needed to reach a favorable compliance determination 28. The user is normally a human user, but can also be a computer.

### C. SMT Solver Execution Mechanism

With reference to the upper portion of FIG. 3, in a first rule evaluation 27 embodiment, the DSL rules 21 are evaluated 27 using an SMT (Satisfiability Modulo Theories) solver 31, specifically Z3 or another theorem prover.

SMT solvers 31 provide several advantages for evaluation 27 of policy rules 21: (1) they 31 contain expressive logic supporting Boolean logic, arithmetic, comparisons, and custom theories; (2) they 31 employ automated reasoning with efficient algorithms for evaluating complex logical expressions; (3) they 31 offer constraint solving with the ability to find satisfying assignments or prove unsatisfiability; and (4) they 31 can prove correctness through formally verified implementations with soundness guarantees.

For this SMT-based execution 34 embodiment, the DSL rules 21 are translated 30 into the input format that is recognized by the SMT solver 31. The main computer defines a three-valued Boolean data type with three constructors (TRUE_VAL, FALSE_VAL, UNKNOWN_VAL). Three-valued logical operations are implemented using conditional expressions that implement the Kleene K3 truth tables. Variables are bound 26 to their three-valued Boolean values based on question 23 answers. The rule 21 expressions are evaluated by the solver 31 to determine the compliance result.

While a preferred embodiment uses Z3, this embodiment is not limited to any specific SMT solver 31. Alternative implementations may use other SMT solvers 31 (CVC5, Yices, etc.), SMT-LIB standard format for solver interoperability, custom DSL interpreters, or compiled execution (DSL translated to native code). The key requirement is deterministic evaluation of three-valued logic expressions with the semantics described herein.

### D. Alternative Neural Model Execution

In an alternative rule evaluation 27 embodiment, illustrated in the lower portion of FIG. 3, instead of using an SMT solver 31 for symbolic execution (evaluation) of the DSL rules 21, the main computer accesses a neural network model 45 trained (or fine-tuned at step 40) to execute the DSL rules 21.

Such a neural network model 45 trained to emulate the information extraction of a large LLM (i.e., distillation) combined with a frozen logic representation 39 derived from DSL 21 semantics can advantageously provide lower latency and hardware acceleration through GPU parallel evaluation.

At Inference Time, the neural execution model 45 takes as input the same input document 24 as for the SMT-based execution 34 model. This document 24 is encoded by the model's encoding/embedding layers 37, then fed directly to intermediate layers to extract variable bindings, which provide the inputs to the terminal logic layers 39 that represent DSL logic 21. The model 45 outputs rule evaluation results (TRUE, FALSE, or UNKNOWN), optional confidence score for the evaluation, and optional explanation through intermediate values - in particular, the variable bindings provide explainable insight into the nondeterministic portion of the model 45 (as the logic layers 39 are frozen and represent DSL logic 21 exactly).

The neural model 45 is trained using supervised learning from SMT solver 31 outputs (i.e., the method is to generate diverse rule expressions 21 and variable bindings 26, evaluate using SMT solver 31 to produce ground truth labels, then train the neural model 45 to match SMT solver 31 outputs), and/or using synthetic data generation (algorithmically generate rule expressions covering full DSL syntax 21, generate all possible variable binding combinations 26 for smaller rules 21, use truth tables to label training examples), or fine-tune 40 the variable bindings 26 from pretrained models 45.

To maintain determinism and prevent the neural model 45 from introducing non-deterministic behavior, architectural constraints include: (1) disabled sampling with the model 45 operating in greedy decode mode; and (2) symbolic grounding with model 45 architecture including explicit components for logical operations.

A proof-of-concept neural execution model 45 has been successfully developed and validated against an SMT solver 31 implementation, demonstrating feasibility of neural execution while maintaining deterministic, explainable properties.

### E. Advantages and Design Considerations

The question-based implementation 22 with three-valued logic 17 of the second embodiment provides numerous advantages compared to the prior art.

Compared to prior art approaches, the question-based implementation 22 provides: (1) explicit uncertainty representation 17 with UNKNOWN as a typed value versus the confidence scores of the prior art; (2) hallucination prevention through explicit UNKNOWN prompting 25 (the prior art encourages maximizing answer coverage, leading to guessing; whereas the present invention explicitly instructs 25 the second language model to return UNKNOWN rather than guess); (3) epistemic clarity distinguishing known-false from unknown (the prior art treats absent information as false or filters it out, while the present invention provides three-valued determinations 17); and (4) actionable reporting 18 identifying specific information gaps (the prior art reports “insufficient confidence” without specifics; whereas the present invention explicitly reports 18 which questions 23 could not be answered).

This second embodiment is particularly suited for simple attribute extraction where policy rules 10 primarily check independent attributes rather than complex relationships; explicit uncertainty requirements mandating cannot-determine outcomes 17 (for high-stakes compliance where guessing is unacceptable, e.g., where there are regulatory requirements for documenting information gaps); performance-critical applications requiring lower latency (e.g., real-time policy enforcement, high-throughput compliance screening); and simplified deployment scenarios valuing fewer components without graph database requirements.

Compared to the triple-based first embodiment illustrated in FIG. 1, the question-based embodiment (second embodiment) illustrated in FIGS. 2 and 3 provides: (1) simpler extraction with questions 23 versus triples 12 (the triple-based embodiment must identify subject-predicate-object relationships; the question-based embodiment answers individual questions 23 independently); (2) no ontology 11 is required (the triple-based embodiment requires entity types and relationship types; the question-based embodiment uses a flat question list 23); (3) overcoming the explicit uncertainty inherent in three-valued logic (the triple-based embodiment produces binary compliance determination; while the question-based embodiment produces three-valued determination 17 with UNKNOWN propagation); (4) reduced overhead with direct variable binding 26 versus graph 13 construction (the triple-based embodiment builds 6 a knowledge graph 13 then queries 7 the graph 13; the question-based embodiment binds 26 variables then evaluates 27 the rules 21); and (5) more flexible execution 27, with the SMT solver 31 and neural model 45 options.

### IV. Comparative Analysis of Embodiments

### A. Triple-Based Embodiment

The triple-based embodiment (first embodiment) of FIG. 1 is preferable when: (1) complex relational information is required, with policy rules 10 requiring understanding relationships between and among multiple entities; (2) entity-centric policies focus on properties of recurring entities; (3) reusable knowledge enables building a knowledge graph 13 once, then evaluating many different policies against it 13; or (4) graph 13 reasoning benefits from graph 13 algorithms (transitive relationships, path finding, community detection).

### B. Question-Based Embodiment

The question-based embodiment (second embodiment) illustrated in FIGS. 2 and 3 is preferable when: (1) simple attribute extraction is sufficient, with policy rules 10 primarily checking independent attributes rather than complex relationships; (2) explicit uncertainty requirements mandate cannot-determine outcomes (for high-stakes compliance where guessing is unacceptable, e.g., when there are regulatory requirements for documented information gaps); (3) performance-critical applications require lower latency (e.g., real-time policy enforcement, high-throughput compliance screening); (4) simplified deployment is valued (because there are fewer components without a graph 13 database, implying simpler debugging and maintenance); or (5) practical deployment has proven questions handle most policy scenarios effectively.

### C. Hybrid Approach

The main computer may employ a hybrid approach using the question-based extraction embodiment of FIGS. 2 and 3 for simple attributes and the triple-based extraction embodiment of FIG. 1 for complex relational information, combining both extraction mechanisms in a unified evaluation.

### V. Exemplary Use Cases and Applications of the Present Invention

### A. Healthcare Compliance

HIPAA (Health Insurance Portability and Accountability Act) Privacy Rules: Verify that patient information access requests comply with HIPAA by generating questions about requestor identity, treating provider status, and authorization presence. Three-valued logic handles CANNOT-DETERMINE when authorization status is unknown.

Medicare Coverage Determinations: Verify that procedures meet Medicare coverage criteria by generating questions about beneficiary age, health risk assessment inclusion, and prevention plan inclusion. Explicit UNKNOWN handling is crucial for incomplete visit documentation.

### B. Financial Services Compliance

Anti-Money Laundering (AML): Screen transactions for suspicious activity by generating questions about transaction amount, destination jurisdiction, jurisdiction risk rating, and related transaction history. CANNOT-DETERMINE outcome triggers manual review when information gaps exist.

Know Your Customer (KYC): Verify customer identity and eligibility by generating questions about identity documents provided, customer risk rating, and additional documentation. Missing documentation is explicitly flagged via UNKNOWN rather than guessed.

### C. Procurement and Vendor Management

Vendor Eligibility: Verify vendors meet procurement requirements by generating questions about business license status, insurance coverage amount, and debarment history. Return CANNOT-DETERMINE for vendors with incomplete documentation, which triggers follow-up.

Contract Compliance: Verify deliverables meet contract terms by generating questions about source code inclusion, documentation inclusion, and test coverage percentage. Return CANNOT-DETERMINE when test coverage is not reported.

### D. Safety and Security Policy Enforcement

Data Access Control: Verify that access requests comply with security policies by generating questions about manager approval, security training status, and VPN connection location. Three-valued logic ensures denial if ANY requirement is FALSE, and CANNOT-DETERMINE if ANY is UNKNOWN, preventing both false positives and false negatives.

Physical Facility Access: Verify badge access permissions by generating questions about key card validity, contractor status, escort presence, and screening completion. CANNOT-DETERMINE triggers human security review.

### VI. Audit, Explainability, and Regulatory Compliance

### A. Audit Trail Components

The Configuration Time portion of the audit 14, 18 can include one or more of: the original policy document 20 (stored with hash for integrity), extracted policy rules 10 (with timestamps and LLM version), generated ontology/question schema 11, 23, and human review and approval records. The human review embodiment operates as follows. Before the extraction schema 11, 23 is generated, the main computer prompts a human domain expert to review the extracted policy rules 10. The main computer then receives modifications or approvals from the human domain expert, and updates the policy rules 10 as warranted by the feedback received from the human domain expert before generating the extraction schema 11, 23.

The Inference Time portion of the audit 14, 18 can include one or more of: the input document 24 (stored with hash), all language model prompts and responses, extracted information (triples 12 or question-answer pairs 17), variable bindings 26, rule evaluation 7, 27 intermediate steps, final compliance determination 14, 28, timestamps, and indication of the versions of the main computer and language model(s) that were used.

### B. Explainability Features

The main computer generates natural language explanations for compliance determinations 14, 28, identifying which policy rule 10 was violated, what the rule 10 requires in order to be compliant, what findings were made, what specific violation occurred, and what evidence from the input document 24 supports the determination.

For complex policy rule 10 evaluations, visual representations aid understanding through decision trees showing rule evaluation 7, 27 flow, highlighted input document 24 sections supporting each extracted fact, and graph 13 visualizations showing entity relationships (for the knowledge graph 13 embodiment).

### C. Regulatory Compliance

Many regulated industries require algorithmic accountability (demonstrating that automated systems make fair, explainable decisions), the right to an explanation under GDPR (General Data Protection Regulation of the European Union) Article 22 (providing that individuals have the right to an explanation of automated decisions), model validation for FDA (Food and Drug Administration) and financial regulations (demonstrating system accuracy and reliability), and data provenance (tracking origin of all information in decisions). The deterministic symbolic evaluation and comprehensive audit trails 14, 28 provided by the present invention satisfy these requirements.

### VII. Alternative Implementations and Extensions

The present invention encompasses numerous variations and extensions beyond the specific implementations described. For example:
A hybrid information extraction variation combines multiple extraction mechanisms: questions 23 for simple attributes, triples 12 for relational information, direct entity recognition for key entities, and sentiment analysis for subjective policy criteria. An active learning and user feedback feature incorporates user corrections to improve the system by capturing correct answers when users contest determinations, using feedback to fine-tune the language models or adjust prompts given to the language models and build organization-specific models over time. A multi-document compliance feature evaluates compliance across multiple related documents 24 when a policy requires information from multiple sources, tracking which required documents 24 are missing.

A temporal reasoning feature handles time-sensitive policies, policy requirements that change over time, evaluating compliance as of a specific date, and tracking expirations and renewals. Probabilistic extensions may incorporate confidence intervals on numeric values, likelihood scores for UNKNOWN values 17 (how likely is this to be TRUE vs. FALSE if complete information were available), and risk-weighted compliance scores, while maintaining the core three-valued logic 25 innovation.

The present written description refers to a “main computer” (not explicitly illustrated), which performs many of the method steps that are shown in the drawing Figures. The main computer can be any suitable digital computing device (machine). A set of programming instructions causes the main computer to perform any one or more of the method steps discussed herein. In some embodiments, the main computer operates as a standalone device, while in other embodiments the main computer can be connected (e.g., networked) to other computers. In a networked deployment, the main computer can operate in the capacity of a server, a client computer in a server-client network environment, or as a peer computer in a peer-to-peer (or distributed) network environment. The main computer can be or can comprise a personal computer (PC), tablet PC, cellular telephone, Web appliance, network router, switch, bridge, or any device capable of executing a set of instructions (sequential or otherwise) that specify actions to be taken by that device. Further, while only a single main computer is contemplated, the term “main computer” is deemed to include any collection of devices that separately or jointly execute a set (or multiple sets) of instructions to perform any one or more of the methods discussed herein.

The main computer may comprise at least one processor (e.g., a central processing unit, a GPU, etc., singly or in combination), and memory, which may comprise a main memory and a static memory. The main computer may further comprise a video display, an audio signal generation device (e.g., a speaker), and/or a network interface device. In addition, the main computer may comprise at least one input device, such as an alphanumeric input device (e.g., a keyboard), a cursor control device (e.g., a mouse), a microphone, a digital camera, etc. Communication among the components of the main computer may be accomplished via a bus. The main computer can be implemented in a variety of ways—for example, a speech processing system can be used to input the user's instructions; and a holographic display, television monitor, or billboard display can be used in lieu of or in addition to the aforementioned video display.

A drive unit including at least one computer-readable medium can be used to store the one or more sets of instructions and/or data embodying or utilized by the main computer. The instructions can also reside, completely or at least partially, within the main memory and/or within the processors during execution by the main computer. The main memory and the processors of the main computer also constitute machine-readable media. All the modules of the present invention can be embodied in an embedded system in an FPGA or SOC (system on a chip), with everything embedded in a single processor.

The programming instructions can be transmitted to or received by the main computer over a communications network via a network interface device utilizing any one of a number of well-known transfer protocols (e.g., Hyper Text Transfer Protocol (HTTP), Controller Area Network, Serial, and Modbus). The communications network may include the Internet, local intranet, PAN, LAN, WAN, Metropolitan Area Network, VPN, cellular network, Bluetooth radio, or an IEEE 802.9-based radio frequency network, etc.

While the computer-readable medium containing the instructions for the main computer can be a single medium, the term “computer-readable medium” includes a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the main computer and that causes the main computer to perform any one or more of the methods of the present invention, or that is capable of storing, encoding, or carrying data utilized by or associated with such a set of instructions. The term “computer-readable medium” shall accordingly be taken to include, but not be limited to, solid-state memories, optical media, and magnetic media. Such media can include, without limitation, hard disks, floppy disks, flash memory cards, digital video disks, random access memory, read only memory, and the like.

The example embodiments described herein can be implemented in an operating environment comprising computer-executable instructions installed on the main computer, in software, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written utilizing any number of suitable programming languages such as, for example, HyperText Markup Language (HTML), Dynamic HTML, Extensible Markup Language, Extensible Stylesheet Language, Document Style Semantics and Specification Language, Cascading Style Sheets, Synchronized Multimedia Integration Language, Wireless Markup Language, Java™, Jini™, C, C++, C#, Go, .NET, Adobe Flash, Perl, UNIX Shell, Visual Basic, Visual Basic Script, Virtual Reality Markup Language, ColdFusion™ Objective-C, Scala, Clojure, Python, JavaScript, HTML5 or any other compilers, assemblers, interpreters, or any other computer languages or platforms, as one of ordinary skill in the art will recognize.

The foregoing description of illustrated embodiments of the present invention, including what is described in the Abstract of the Disclosure, is not intended to be exhaustive or to limit the invention to the precise forms disclosed herein. While specific embodiments of, and examples for, the invention are described herein for illustrative purposes, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the present description, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. The scope of the invention is to be determined solely by the following claims:

1. A computer-implemented method for neurosymbolic policy compliance determination, comprising:
a configuration phase comprising:
receiving at least one natural language policy document;
processing the policy document(s) using a first language model to extract a plurality of formal policy rules, wherein each policy rule represents a compliance requirement or constraint expressed in the at least one policy document;
analyzing the extracted policy rules to identify a set of minimum required information elements necessary to evaluate the policy rules; and
generating an extraction schema defining the required information elements, wherein the extraction schema is derived from the policy rules and contains only information required to evaluate the policy rules; and
an inference phase comprising:
receiving a natural language input document to be evaluated for compliance;
extracting structured information from the input document using a second language model guided by the extraction schema, wherein the extracted structured information comprises only information corresponding to the required information elements defined in the extraction schema;
evaluating the plurality of policy rules against the extracted structured information using deterministic symbolic reasoning to produce a compliance determination; and
generating an audit trail comprising provenance information linking the compliance determination to the extracted structured information and the input document.

2. The method of claim 1, wherein:
the extraction schema is a minimum viable extraction schema containing only information elements that are necessary to evaluate at least one of the plurality of policy rules; and
the method further comprises determining the minimum viable extraction schema by:
identifying variables, predicates, and conditions appearing in the policy rules;
determining data types and structural relationships required by the policy rules; and
excluding information elements that are not required by any of the plurality of policy rules.

3. The method of claim 1, wherein the extracted structured information comprises a set of triples, each triple comprising a subject, a predicate, and an object, and evaluating the plurality of policy rules comprises:
constructing a knowledge graph or alternative graph representation from the set of triples; and
executing graph queries or pattern matching operations against the knowledge graph to determine satisfaction of the policy rules.

4. The method of claim 1, wherein:
the extraction schema comprises a question schema defining a plurality of natural language questions, each question corresponding to a required information element;
extracting structured information comprises, for each question:
prompting the second language model to answer the question based on the input document; and
receiving an answer from the second language model, wherein the answer comprises either a value of a specified data type or an explicit UNKNOWN indicator; and
the plurality of policy rules are evaluated using the answers as variable bindings in a symbolic reasoning system.

5. The method of claim 4, wherein the question schema is generated by:
analyzing variable names or parameter identifiers in the policy rules;
prompting a third language model to generate a natural language question for each variable, wherein the question is designed to elicit information represented by the variable; and
determining a data type for each question using the third language model, wherein the data type is selected from a group consisting of: Boolean, Numeric, Enumerated, and String types.

6. The method of claim 4, wherein each question is associated with a typed data domain, and the UNKNOWN indicator is a full member of each typed data domain, such that:
for Boolean-typed questions, possible answer values comprise {TRUE, FALSE, UNKNOWN};
for Numeric-typed questions, possible answer values comprise {numeric value, UNKNOWN}; and
for Enumerated-typed questions, possible answer values comprise {enum_member_1, enum_member_2, . . . , enum_member_N, UNKNOWN}.

7. The method of claim 6, wherein prompting the second language model to answer a question comprises including explicit instructions to:
return the UNKNOWN indicator when the question cannot be answered based on information present in the input document;
refrain from inferring, guessing, or hallucinating information not explicitly stated in the input document; and
prioritize precision over recall by defaulting to UNKNOWN when uncertain.

8. The method of claim 6, further comprising:
after receiving an answer from the second language model, performing entailment verification comprising:
formulating a hypothesis statement based on the question and the received answer;
prompting a verification language model to determine whether the input document entails the hypothesis statement;
receiving an entailment determination from the verification language model; and
when the entailment determination indicates that the input document does not entail the hypothesis statement, overriding the received answer with the UNKNOWN indicator.

9. The method of claim 6, wherein evaluating the plurality of policy rules comprises:
binding variables in the policy rules to corresponding answers, wherein unanswered questions result in unbound variables;
treating unbound variables as having the UNKNOWN value; and
evaluating the policy rules using three-valued logic, wherein logical operations propagate UNKNOWN values according to a three-valued logic semantics.

10. The method of claim 9, wherein the three-valued logic semantics comprise Kleene K3 logic, wherein:
TRUE AND UNKNOWN evaluates to UNKNOWN;
FALSE AND UNKNOWN evaluates to FALSE;
TRUE OR UNKNOWN evaluates to TRUE;
FALSE OR UNKNOWN evaluates to UNKNOWN; and
NOT UNKNOWN evaluates to UNKNOWN.

11. The method of claim 9, wherein the compliance determination comprises one of:
COMPLIANT, when all policy rules evaluate to TRUE;
NON-COMPLIANT, when at least one policy rule evaluates to FALSE; or
CANNOT-DETERMINE, when no policy rules evaluate to FALSE and at least one policy rule evaluates to UNKNOWN.

12. The method of claim 11, further comprising:
when the compliance determination is CANNOT-DETERMINE, identifying information gaps by:
determining which questions received the UNKNOWN indicator;
determining which policy rules evaluated to UNKNOWN due to the unanswered questions; and
generating a report specifying the questions that could not be answered and explaining how answering those questions would affect the compliance determination.

13. The method of claim 6, wherein generating the extraction schema comprises:
analyzing the policy rules to identify variables;
for each variable, using a third language model to:
generate a descriptive natural language question based on the variable name;
determine a data type for the variable;
when the data type is Numeric, determine units of measurement;
when the data type is Enumerated, determine possible enumeration values; and
compiling the generated questions, data types, units, and enumeration values into a structured question schema.

14. The method of claim 9, wherein evaluating the plurality of policy rules using three-valued logic comprises:
translating the policy rules into a domain-specific language (DSL) that supports trinary assertions, wherein each assertion can evaluate to TRUE, FALSE, or UNKNOWN;
binding DSL variables to answer values, wherein unbound variables are treated as UNKNOWN;
executing the DSL using a Satisfiability Modulo Theories (SMT) solver configured to implement three-valued logic semantics; and
extracting compliance determinations from the SMT solver results.

15. The method of claim 14, wherein the SMT solver is Z3, CVC5, Yices, or an SMT solver compatible with SMT-LIB format.

16. The method of claim 9, wherein evaluating the plurality of policy rules using three-valued logic comprises:
encoding the policy rules and the answer values as architecture and training inputs to a neural network;
executing the neural network to produce a rule evaluation result comprising one of TRUE, FALSE, or UNKNOWN for each policy rule; and
aggregating the rule evaluation results to produce the compliance determination; wherein the neural network has been trained to emulate three-valued logic semantics by supervised learning from labeled examples generated using symbolic evaluation.

17. The method of claim 16, wherein the neural network is constrained to operate deterministically by:
disabling stochastic sampling during inference;
using greedy decoding or beam search with beam size of 1.

18. The method of claim 4, wherein the data type for numeric questions includes unit specifications, and wherein the method further comprises:
receiving a numeric answer with associated units from the second language model;
when the received units differ from expected units specified in the question schema, performing unit conversion; and
using the converted numeric value in policy rule evaluation.

19. The method of claim 1, wherein evaluating the plurality of policy rules using deterministic symbolic reasoning comprises:
translating the policy rules into a formal logic representation compatible with a Satisfiability Modulo Theories (SMT) solver;
encoding the extracted structured information as constraints or assertions in the SMT solver; and
invoking the SMT solver to determine whether the policy rules are satisfied by the extracted structured information.

20. The method of claim 1, further comprising:
before generating the extraction schema, prompting a human domain expert to review the extracted policy rules;
receiving modifications or approvals from the human domain expert; and
updating the extracted policy rules based on the received modifications;
wherein the extraction schema is generated only after human approval of the policy rules.

21. The method of claim 1, wherein one of the two following statements is true:
the first language model and the second language model are the same language model;
the first language model and the second language model are different language models selected based on task-specific performance requirements.

22. The method of claim 1, wherein generating the audit trail comprises:
storing the input document with a cryptographic hash for integrity verification;
recording all prompts sent to language models and all responses received;
recording the extracted structured information with references to source locations in the input document;
recording intermediate evaluation steps during policy rule evaluation; and
digitally signing the audit trail to prevent tampering.

23. At least one non-transitory computer-readable storage medium storing instructions for performing the following steps of neurosymbolic policy compliance determination:
in a configuration phase:
receiving at least one natural language policy document;
processing the policy document(s) using a first language model to extract a plurality of formal policy rules, wherein each policy rule represents a compliance requirement or constraint expressed in the at least one policy document;
analyzing the extracted policy rules to identify a set of minimum required information elements necessary to evaluate the policy rules; and
generating an extraction schema defining the required information elements, wherein the extraction schema is derived from the policy rules and contains only information required to evaluate the policy rules; and
in an inference phase:
receiving a natural language input document to be evaluated for compliance;
extracting structured information from the input document using a second language model guided by the extraction schema, wherein the extracted structured information comprises only information corresponding to the required information elements defined in the extraction schema;
evaluating the plurality of policy rules against the extracted structured information using deterministic symbolic reasoning to produce a compliance determination; and
generating an audit trail comprising provenance information linking the compliance determination to the extracted structured information and the input document.

24. A computer system for neurosymbolic policy compliance determination, comprising:
configuration phase apparatus comprising:
a module for receiving at least one natural language policy document;
coupled to the module for receiving at least one natural language policy document, a module for processing the policy document(s) using a first language model to extract a plurality of formal policy rules, wherein each policy rule represents a compliance requirement or constraint expressed in the at least one policy document;
coupled to the processing module, a module for analyzing the extracted policy rules to identify a set of minimum required information elements necessary to evaluate the policy rules; and
coupled to the analyzing module, a module for generating an extraction schema defining the required information elements, wherein the extraction schema is derived from the policy rules and contains only information required to evaluate the policy rules; and
inference phase apparatus comprising:
a module for receiving a natural language input document to be evaluated for compliance;
coupled to the module for receiving a natural language input document to be evaluated for compliance, a module for extracting structured information from the input document using a second language model guided by the extraction schema, wherein the extracted structured information comprises only information corresponding to the required information elements defined in the extraction schema;
coupled to the extracting module, a module for evaluating the plurality of policy rules against the extracted structured information using deterministic symbolic reasoning to produce a compliance determination; and
coupled to the evaluating module, a module for generating an audit trail comprising provenance information linking the compliance determination to the extracted structured information and the input document.
